(19) United States
(12) Patent Application Publication
(10) Pub. No.: US 2014/0141671 A1
(43) Pub. Date: May 22, 2014

(54) Structural Composite Panel and Method of Construction Thereof

(71) Applicant: FEDERAL-MOGUL POWERTRAIN, INC., Southfield, MI (US)

(72) Inventors: Marissa Freilich, Bangor, PA (US); Dana Mazzella, Aston, PA (US); Bradley Krohl, Clifton Park, NY (US); Jeffrey Kopczynski, Blackwood, NJ (US); John Pickard, Philadelphia, PA (US); Michael C. Shannon, York, PA (US); Lauren Timko, Freeland, PA (US)

(73) Assignee: FEDERAL-MOGUL POWERTRAIN, INC., Southfield, MI (US)

(21) Appl. No.: 13/682,572

(22) Filed: Nov. 20, 2012

(51) Int. Cl. E04C 2/16; B32B 37/14

(52) U.S. Cl. CPC E04C 2/16; B32B 37/14
USPC 442/1; 156/60; 156/281

(57) ABSTRACT

A structural composite panel and method of construction thereof is provided. The structural composite panel includes a scrim layer, a drywall sheet, and a nonwoven matt sandwiched between the scrim layer and the drywall sheet. The nonwoven matt includes comminuted cardboard and heat bondable textile fibers thermally bonded together to a desired thickness. The method includes providing a nonwoven matt and laminating a scrim layer to one side of the nonwoven matt. Further, providing a drywall sheet and laminating a paper layer to one side of the drywall sheet. The method then includes bonding one side of the nonwoven matt directly to one side of the drywall sheet.

### BACKGROUND OF THE INVENTION

1. Technical Field

This invention relates generally to construction panel materials, and more particularly to structural composite building panel materials and methods of construction thereof.

2. Related Art

In modern construction, various types of drywall products are used to construct interior walls and ceilings. Although the drywall products fastened to interior wood or metal studs provide a durable structure for construction purposes, they are generally bulky, heavy, and susceptible to vapor damage between adjacent walls, costly, environmentally unfriendly, and less than optimal for attenuating noise.

A composite panel material constructed in accordance with the invention overcomes the aforementioned disadvantages of known drywall products, as well as others, as will be readily recognized by those skilled in the art of structural building panel materials.

### SUMMARY OF THE INVENTION

According to one aspect of the invention, a structural composite panel is provided. The structural composite panel includes a scrim layer, a drywall sheet, and a nonwoven matt sandwiched between the scrim layer and the drywall sheet. The nonwoven matt includes comminuted cardboard and heat bondable textile fibers thermally bonded together to a desired thickness.

According to another aspect of the invention, the structural composite panel further includes a scrim layer bonded to a side of the drywall sheet, with the drywall sheet being sandwiched between the scrim layer and the matt.

According to yet another aspect of the invention, the scrim layer on the drywall sheet is formed from recycled newsprint.

According to yet another aspect of the invention, the structural composite panel further includes a chemical mixture applied, dried and cured to at least one outer surface of the matt, wherein the chemical mixture includes at least one of a flame retardant, a biocide and a binder.

According to yet another aspect of the invention, the chemical mixture includes each of the flame retardant, biocide and binder.

In accordance with another aspect of the invention, a method of constructing a structural composite panel is provided. The method includes providing a nonwoven matt and laminating a scrim layer to one side of the nonwoven matt. Further, providing a drywall sheet and laminating a scrim layer to one side of the drywall sheet. Further yet, bonding one side of the nonwoven matt directly to one side of the drywall sheet.

According to yet another aspect of the invention, the method includes constructing the nonwoven matt comprising cardboard and heat bondable textile fibers.

According to yet another aspect of the invention, the method includes forming the scrim layer on the drywall sheet from recycled paper.

According to yet another aspect of the invention, the method includes comminuting the cardboard into predetermined reduced sized pieces and combining the reduced sized pieces with the heat bondable textile fibers to form a substantially homogenous mixture; forming a web from the mixture; and thermally bonding the constituent ingredients of the web to produce the matt of a desired thickness.

According to yet another aspect of the invention, the method includes laminating the scrim layer to the matt without substantially reducing the thickness of the matt.

According to yet another aspect of the invention, the method includes applying a chemical mixture including at least one of a flame retardant, a biocide and a binder to at least one surface of the matt.

According to yet another aspect of the invention, the method includes applying the chemical mixture to the side of the matt opposite the scrim layer.

According to yet another aspect of the invention, the method includes drying and curing the chemical mixture before laminating the scrim layer to the matt.

According to yet another aspect of the invention, the method includes providing the scrim layer on the matt as an impervious layer.

According to yet another aspect of the invention, the method includes laminating the scrim layer to the nonwoven matt to form a first laminated sheet and laminating the scrim layer to the sheet of drywall to form a second laminated sheet and then laminating the first laminated sheet to the second laminated sheet.

Accordingly, the invention herein provides a structural composite panel, such as those suitable for use constructing walls and ceilings, or structural equivalents, requiring acoustic and thermal protection, and a method of construction thereof including the use of recycled and recyclable materials, at least in part, thereby offering a finished structural composite panel that is economical in manufacture, economical in recycling, and environmentally friendly.

### BRIEF DESCRIPTION OF THE DRAWINGS

These and other aspects, features and advantages of the present invention will become more readily appreciated when considered in connection with the following detailed description of presently preferred embodiments and best mode, appended claims and accompanying drawings, in which:

FIG. 1 is a schematic cross-sectional side view of a structural composite panel constructed in accordance with one aspect of the invention;

FIG. 2A is a graph showing the results of a sound test measuring the Decibel (dB) drop against measured frequencies (Hz) of the structural composite panel of FIG. 1;

FIG. 2B is a graph showing the results of a sound test measuring the Decibel (dB) drop against measured frequencies (Hz) of a standard drywall panel constructed in accordance with the prior art; and

FIG. 3 is a process flow diagram illustrating methods of constructing a nonwoven panel in accordance with various aspects of the invention.

### DETAILED DESCRIPTION OF PRESENTLY PREFERRED EMBODIMENTS

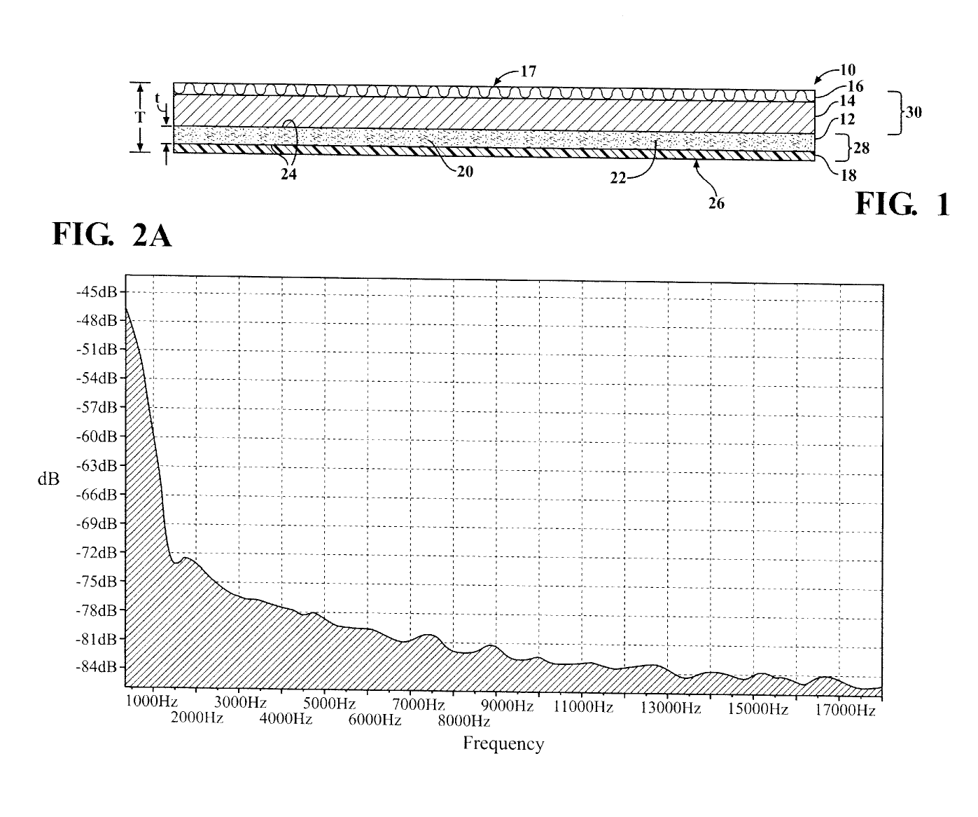

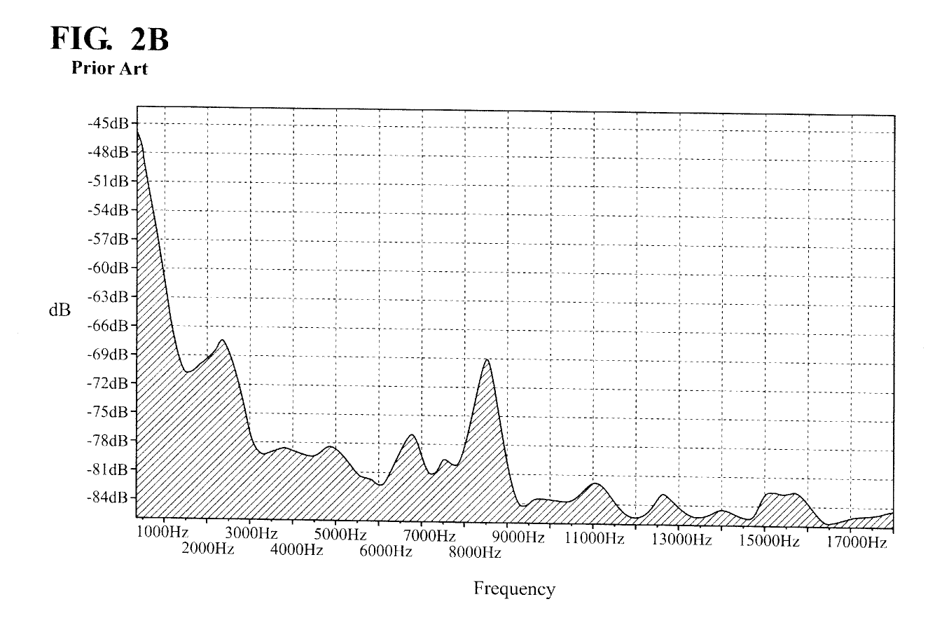

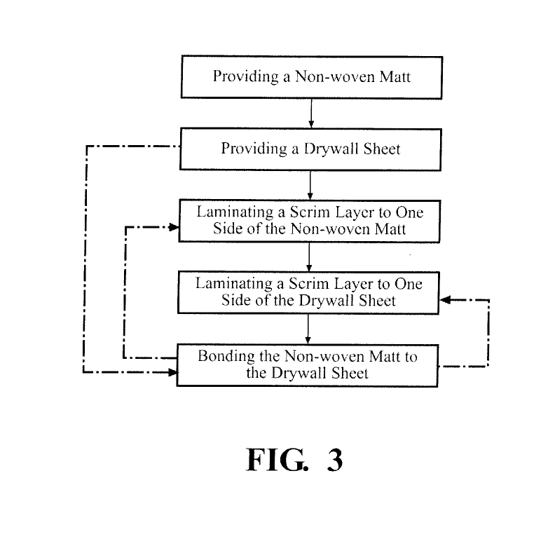

Referring in more detail to the drawings, FIG. 1 illustrates a composite structural building material, also referred to as composite sheet or composite panel 10, constructed in accordance with one aspect of the invention. The panel 10 can be constructed in any suitable size, including a standard 4 ft×8 ft panel commonly used in the construction industry, such as for walls, e.g. interior finish wall or ceiling panel, for example. The panel 10 is constructed having a plurality of separate layers bonded to one another, with each layer being provided as a different type of material, to provide the physical characteristics desired in the finished panel 10. As such, each material type of the separate layers provides a specific physical attribute needed to arrive at the desired synergy of physical attributes of the panel 10.

In particular, the panel 10 includes a “high loft” (i.e. low density) nonwoven matt 12 that provides excellent noise damping or attenuation properties, thus, allowing the panel 10 to function particularly well as an acoustic panel. Further, the panel 10, which can be constructed having a total thickness (T) of about ⅝″ to take on an industry standard thickness of known drywall, includes a relatively thin layer of drywall 14, also known as plasterboard, wallboard or gypsum board, approximately ⅜″ thick, (reduced in thickness relative from standard drywall, which is typically ⅝″ thick) bonded directly to the nonwoven matt 12 to provide structural integrity and strength to the panel 10. Of course, with the thickness of the drywall 14 being reduced from the standard drywall thickness, the weight of the panel is significantly reduced. In addition, the panel 10 includes a scrim layer 16, such as a recycled paper layer, bonded directly to the drywall 14 to provide an exposed, viewable wall surface 17 suitable for painting or wall papering, as desired. Further yet, the panel 10 includes an impervious scrim layer 18 bonded directly to the nonwoven matt 12 to act primarily as a vapor barrier. Further the panel 10 can be constructed having fire retardant properties, such as by incorporating fire retardant materials in the drywall 14 and/or nonwoven matt 12.

The nonwoven matt 12 is constructed, at least in part, from post-consumer cardboard 20, including standard cardboard and/or Asian cardboard, staple fibers, and heat-bondable fibers, e.g. bi-component fibers which are represented generally at 22. Further, the nonwoven matt 12 can be constructed using a chemical mixture coating 24, including a flame retardant, a biocide and a binder, which is applied, dried and cured to at least one outer surface of the nonwoven matt 12.

The scrim layer 18 is attached to one side of the matt 12, wherein the scrim layer 18 provides an exposed side 26 of the panel 10, wherein the scrim layer 18 is attached either by using little to no pressure on nip rollers or not using nip rollers at all, thus retaining or substantially retaining the matt's 12 thickness and low density as initially produced. Accordingly, the finished matt 12 provides a low density structure, “high loft”, with the scrim layer 18, thereby providing excellent noise attenuation properties. Further, with the matt 12 being constructed at least in part from post-consumer or recycled standard or Asian cardboard 14, the environment is benefited, such that the reclaimed cardboard 14 is kept from being sent to landfills, from being incinerated, or otherwise being classified as waste.

The content of the cardboard, whether standard cardboard, mixed with Asian cardboard, or provided from 100% Asian cardboard, is preferably between about 25-99 weight percent (wt %) of the total web weight, depending on the desired performance characteristics of the matt 12 being constructed. Asian cardboard 14 is typically considered to be a low grade, non-recyclable cardboard due to its being constructed from inferior constituent ingredients, such as low quality, very short and fine recycled fibers, e.g. bamboo fibers, jute fibers, rice fibers, and/or other scrap/waste materials. As such, Asian cardboard is typically considered to be a serious non-recyclable waste contaminant, whether on its own or if bailed or otherwise included in reclaimed post consumer cardboard loads. Accordingly, if Asian cardboard is bailed with standard U.S. cardboard or other higher quality cardboard, then the entire bail or load is typically considered to be non-recyclable waste. Asian cardboard can be readily distinguished from higher quality U.S. cardboard by its flimsiness and characteristic pale brown, yellow or greenish color. Accordingly, Asian cardboard is typically separated from higher U.S. quality cardboard, and sent to landfills, burned, or otherwise disposed.

The inability of Asian cardboard to be recycled stems from the constituent ingredients of the inferior fibers used in the construction of the Asian cardboard, which are generally very short and thus very weak. Given the relatively fine size of the fibers and other powdery ingredients in Asian cardboard, if the Asian cardboard is processed in known “wet” recycling processes along with standard cardboard having fibers of an increased length, the ingredients of the Asian cardboard get flushed through the screens and carried into the waste stream, and typically plug and otherwise damage the recycling equipment. Accordingly, in accordance with one aspect of the invention, the construction of the matt 12 is performed in a “dry” webbing process, thereby allowing the utilization of the inferior Asian cardboard along with the fibers having a length less than 0.2 mm (referred to as “fines”) in it's manufacture.

The staple fibers can be provided from any suitable textile fiber that not only retains height in a low density matt but also is light in weight and provides a high level of sound absorption, and the heat bondable fibers can be provided, for example, as a low temperature melt polymeric material, such as fibers of polyethylene, PET or Nylon, and/or thermoplastic bi-component fibers whose outer sheath, such as polypropylene, for example, melts when heated above its melting point. The process for constructing the matt 12 includes mixing or blending the comminuted cardboard 20 with the staple fibers and heat-bondable fibers 22 to form a web. The webbing process, which may be performed, for example, on a Rando machine, forms a homogenously mixed fiber/paper mat or web, with the fibers of the cardboard 20 being randomly oriented.

Then, upon forming the web, the web is heated, such as in an oven, to a temperature suitable to melt the heat-bondable fibers, (e.g., the melting point of the outer portion of a bi-component low melt fiber may be approximately 110° C.-180° C.), thereby thermally bonding the blend of cardboard 20 with the staple fibers and heat-bondable fibers 22. As such, the web is formed into the matt 12, wherein the matt 12 attains a desired high loft, low density increased thickness t.

Then, upon forming and cooling the matt 12, the chemical mixture 24, including at least one of a heat resistant or flame retardant (FR) coating, such as Ammonium Sulfate, Ammonium Phosphate, or Boric Acid, for example, a biocide and a binder, by way of example and without limitation, SBR with a Tg of +41, can be applied, such as in a spraying process, to at least one side, and preferably to the entire outer surface of the matt 12. The spraying application of the chemical mixture 24 acts to maintain the thickness of the matt 12, thereby preserving its high loft, low density, and thus, its noise attenuating properties. Upon applying the mixture 24, the mixture 24 is then dried and cured to the matt 12. The resulting coated, nonwoven matt 12 then has the thin impervious film layer, previously referred to as scrim layer 18, such as a thin foil layer, e.g. aluminum foil Kraft paper, which is environment-friendly, anti-fungal & anti-bacteria, water resistant, has an excellent ignitability rating, and is ISO9001:2008 qualified, attached or bonded to one of its sides. The scrim layer 18 is bonded to the side of the matt 12 using a suitable heat resistant adhesive. It is beneficial that the thickness t of the matt 12 be maintained or substantially maintained while attaching the scrim layer 18 in order to retain the high loft, low density of the matt 12 as initially formed, thereby maintaining maximized noise attenuating properties of the matt 12. This can be attained by either not using a nip roller or using one with little to no pressure. If higher pressures are used on the nip roll, it would tend to compact the thickness t of the matt 12, thereby causing it to become increased in density, reduced in thickness, and thus, diminishing its targeted noise attenuating properties. The higher retained thickness, along with the scrim layer 18, combines to attenuate lower sound frequencies.

In another portion of the process used to construct the panel 10, the drywall 14 is fabricated in a drywall board machine. As constructed, the drywall 14 has the scrim layer 16, e.g. recycled paper, such as recycled or reclaimed newsprint, bond to one of its sides. The paper layer 16 provides the clean side 17 of the panel 10 that remains exposed for painting or wallpapering.

Then, the finished matt 12, with scrim layer 18 bonded to one of its sides, constituting a first laminate sheet 28, is bonded directly to the uncovered, exposed side of the drywall 14, opposite the paper layer 16, using any suitable adhesive, wherein the drywall 14 and scrim layer 16 constitute a second laminated sheet 30. Accordingly, the multilayered composited panel 10 is completed, with each bonded layer providing the physical characteristics needed to maximize the useful benefits of the structural panel 10. Though, it should be understood that the order of laminating steps can be varied, as desired, to arrive at the laminated panel 10. For example, the nonwoven matt 12 can be directly bonded to the drywall sheet 14 in a first step, and thereafter, the respective scrim layers 16, 18 can be bonded to the respective exposed sides of the nonwoven matt 12 and drywall sheet 14.

Obviously, many modifications and variations of the present invention are possible in light of the above teachings. It is, therefore, to be understood that within the scope of the appended claims, the invention may be practiced otherwise than as specifically described.

What is claimed is:

1. A structural composite panel, comprising:
a scrim layer;
a drywall sheet;
a nonwoven matt sandwiched between said scrim layer and said drywall sheet, said nonwoven matter having comminuted cardboard and heat bondable textile fibers thermally bonded together to a desired thickness.

2. The structural composite panel of claim 10 further including a paper layer bonded to a side of said drywall sheet, said drywall sheet being sandwiched between said paper layer and said matt.

3. The structural composite panel of claim 2 wherein said paper layer is formed from recycled waste paper.

4. The structural composite panel of claim 3 wherein said paper layer is formed from recycled newsprint.

5. The structural composite panel of claim 1 wherein said matt has a thickness substantially retained as initially produced.

6. The structural composite panel of claim 1 further including a chemical mixture applied, dried and cured to at least one outer surface of said matt, said chemical mixture including at least one of a flame retardant, a biocide and a binder.

7. The structural composite panel of claim 6 wherein said chemical mixture includes each of said flame retardant, biocide and binder.

8. The structural composite panel of claim 6 wherein said chemical mixture is applied at least to the side of said matt attached to said scrim layer.

9. A method of constructing a structural composite panel, comprising:
providing a nonwoven matt;
laminating a scrim layer to one side of the nonwoven matt;
providing a sheet of drywall;
laminating a paper layer to one side of the sheet of drywall; and
bonding one side of the nonwoven matt directly to one side of the sheet of drywall.

10. The method of claim 9 further including constructing the nonwoven matt comprising cardboard and heat bondable textile fibers.

11. The method of claim 10 further comprising:
comminuting the cardboard into predetermined reduced sized pieces and combining the reduced sized pieces with the heat bondable textile fibers to form a substantially homogenous mixture;
forming a web from the mixture; and
thermally bonding the constituent ingredients of the web to produce the matt of a desired thickness.

12. The method of claim 11 further comprising laminating the scrim layer to the matt without substantially reducing the thickness of the matt.

13. The method of claim 9 further including applying a chemical mixture including at least one of a flame retardant, a biocide and a binder to at least one surface of the matt.

14. The method of claim 13 further including providing the chemical mixture including a flame retardant, a biocide and a binder.

15. The method of claim 13 further including applying the chemical mixture to the side of the matt opposite the scrim layer.

16. The method of claim 13 further including drying and curing the chemical mixture before laminating the scrim layer to the matt.

17. The method of claim 9 further including providing the scrim layer as an impervious layer.

18. The method of claim 9 further including laminating the scrim layer to the nonwoven matt to form a first laminated sheet and laminating the paper layer to the sheet of drywall to form a second laminated sheet and then laminating the first laminated sheet to the second laminated sheet.
